(19) United States
(12) Patent Application Publication
(10) Pub. No.: US 2025/0237329 A1
(43) Pub. Date: Jul. 24, 2025

(54) Rigid Tube for Inserts

(71) Applicant: Mark R. Smith, Palo Alto, CA (US)

(72) Inventor: Mark R. Smith, Palo Alto, CA (US)

(21) Appl. No.: 19/035,093

(22) Filed: Jan. 23, 2025

Related U.S. Application Data
(60) Provisional application No. 63/624,206, filed on Jan. 23, 2024.

(51) Int. Cl. F16L 9/00

(52) U.S. Cl. CPC F16L 9/00

(57) ABSTRACT

A rigid tube with elements for quick connection, retention, alignment and motion control system for connecting, aligning and controlling insertion hands-free.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING

### Compact Disk Appendix

Not Applicable

### BACKGROUND

### Prior Art

The following is a tabulation of some prior art that presently appears relevant:

U.S. patents

| Pat. No. | Kind Code | Issue Date | Patentee |
|---|---|---|---|
| U.S. Pat. No. 9,968,195 | B2 | May 15, 2018 | Sheinkop |
| U.S. Pat. No. 8,187,208 | B2 | May 9, 2012 | Egorov |
| U.S. Pat. No. 11,266,343 | B2 | May 29, 2022 | Iglesias |
| U.S. Pat. No. 7,628,455 | B2 | Dec. 8, 2009 | Brodeur |
| U.S. Pat. No. 3,890,004 | A | Jun. 7, 1975 | Rail |
| U.S. Pat. No. 5,134,740 | A | Aug. 4, 1992 | Summer |
| U.S. Pat. No. 10,022,293 | B2 | Jul. 17, 2018 | Scheuring |
| EP3267960 | B1 | Jun. 7, 2023 | Lenke |
| U.S. Pat. No. 7,993,315 | B2 | Aug. 9, 2011 | Matsuura |

### BACKGROUND OF THE INVENTION

The present invention is in the technical field of human factors engineering related to body position, stability, alignment, motion control, balance, lever action and safety. More particularly, the present invention is in the technical field of position, stability, alignment, motion control and safety to achieve benefits in ergonomic and human factors design specifically related to range of motion control and positioning for hands-free use of the invention. The present invention is also applicable to the field of robotics. Neurotransmitters related to pleasure and endogenous opioids are invoked when nerve bundles linked to pleasure in the human body are activated. Devices which leave both hands available to touch erogenous nerve centers around the human body augment the effectiveness of devices. One question: what body position works best when pursuing a pleasure response? One answer: Humans are upright. Having the torso upright leads to the best blood flow and a slight lean of the torso in the reclined position engages the stomach muscles and pelvic area. As a multifunctional invention, the novel aspects are: 1. Dual-ended reversibility. The base of the rigid tube flips and becomes the top with mount points to create the elevation for facilitation of optimized body position via weight offset and balance point and a lever. 2. Transformation. The rigid tube transforms into a simulated body orifice with the addition of flat fluffy material to form a role. 3. The rigid tube becomes a drying rack with the option to use a blow dryer to blow air through the uncovered top. Other functions include: 1. theft resistant protective packaging for shipping and retail 2. protective case for travel and carrying 3. water bottle design acts as a privacy shield 4. stand 5. weighted base when tube is reversed and water is added 6. sanitizing tube when boiling water or UV light is added. 7. handle

Objects which may be mounted or positioned hands-free at an appropriate angle aid with body positioning in the interaction with pleasurable nerve centers. For optimal performance devices must remain stable while in use because a user's body weight is involved.

In the case where the device must be held or moved a user will feel more confident if the device has a comfortable handle. The tube can be considered a handle and additional elements can be added to make it more handle like. Additional elements can be added to the tube to prevent marring of other surfaces and to deaden any sound from the use or droppage. The device should conform to the precise motion control of the user and should not be unstable wobble or jiggle unless this motion is desired.

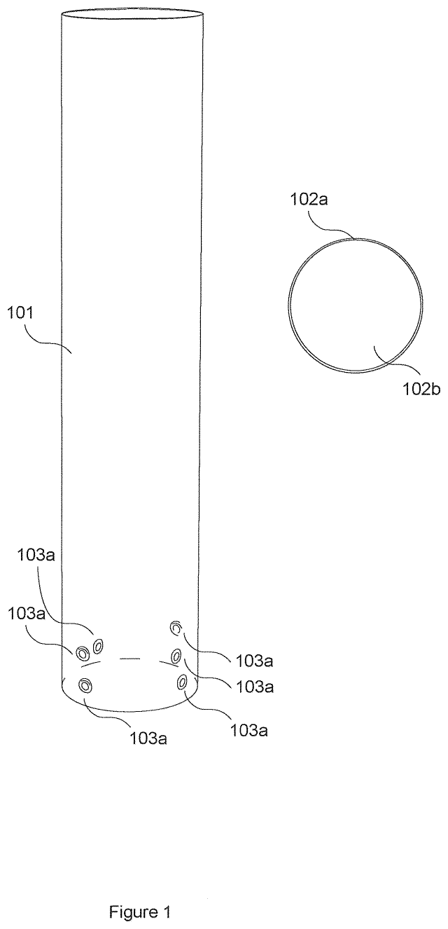

FIG. 1 of the invention shows a front perspective view of a 6061 grade aluminum tube or similar or similar with three threaded holes at the base and a top view of the tube's shape.

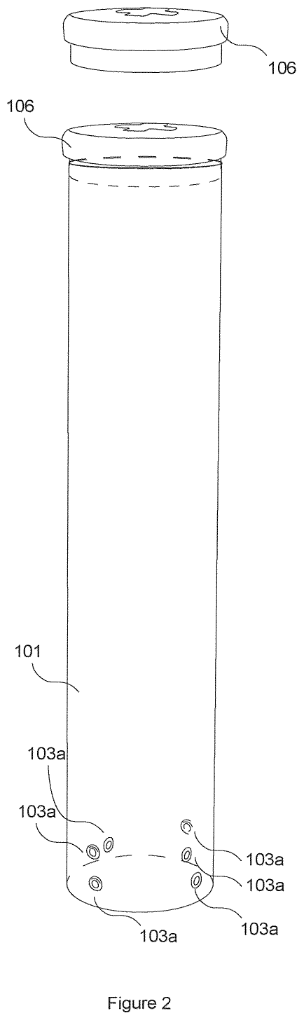

FIG. 2 of the invention shows a front perspective view of an 6061 grade aluminum tube or similar with three threaded holes at the base and a watertight cap.

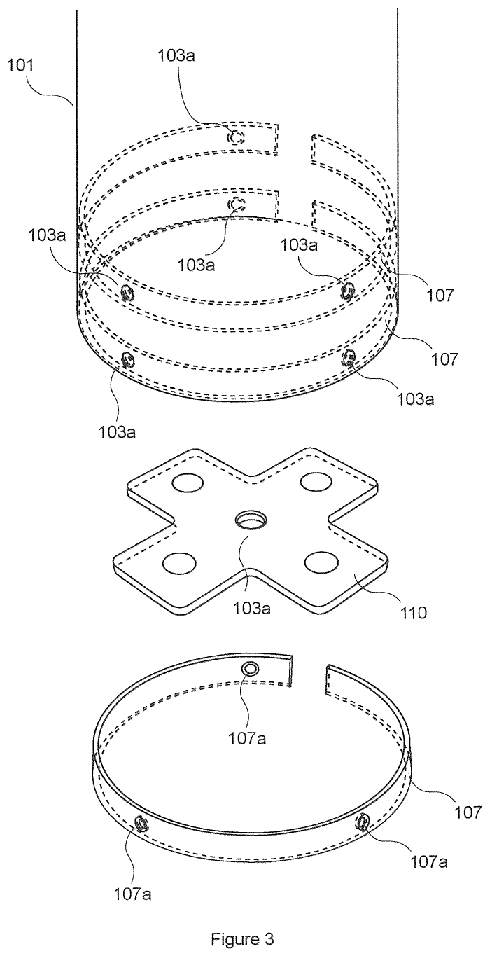

FIG. 3 of the base of the invention shows a close-up front perspective view of a retention ring which when used as a pair the rings retain the plus shaped mount at the base of 6061 grade aluminum tube or similar with three threaded holes at the base.

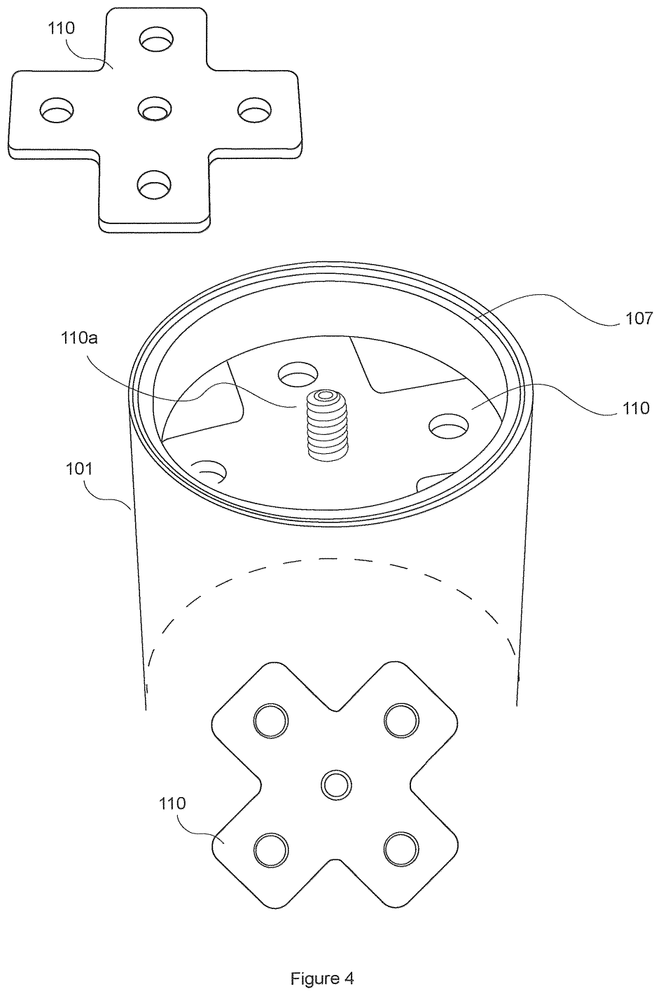

FIG. 4 of the base of the invention shows a close-up front perspective view of a retention ring retaining the plus shaped mount point with a threaded set screw.

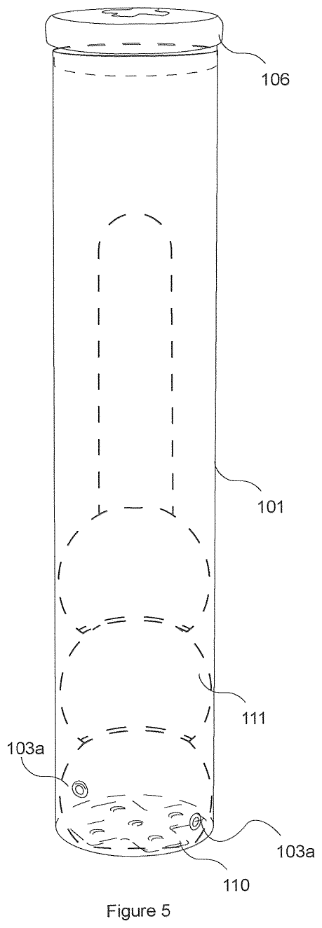

FIG. 5 of the invention shows a perspective view of the 6061 grade aluminum tube or similar with the watertight cap with an insert inside the tube.

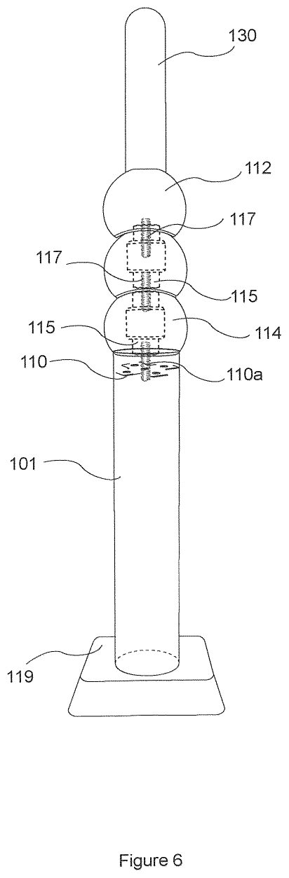

FIG. 6 of the invention shows a front view of the insert attached to the 6061 grade aluminum tube or similar to extend the reach position of the insert.

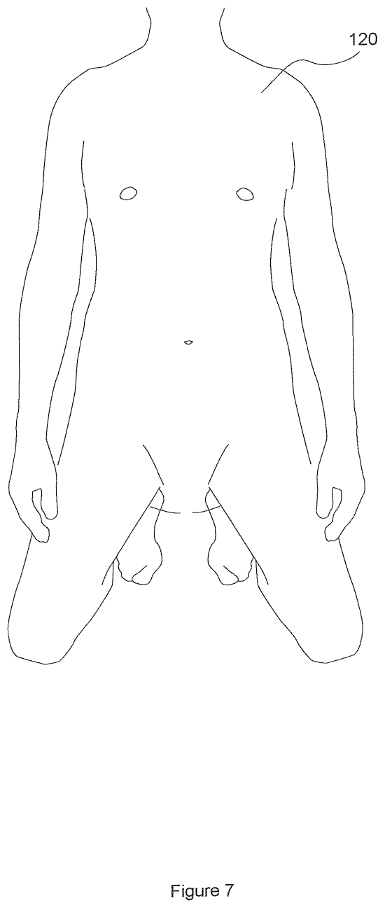

FIG. 7 shows the front perspective view of a user in an upright kneeling position.

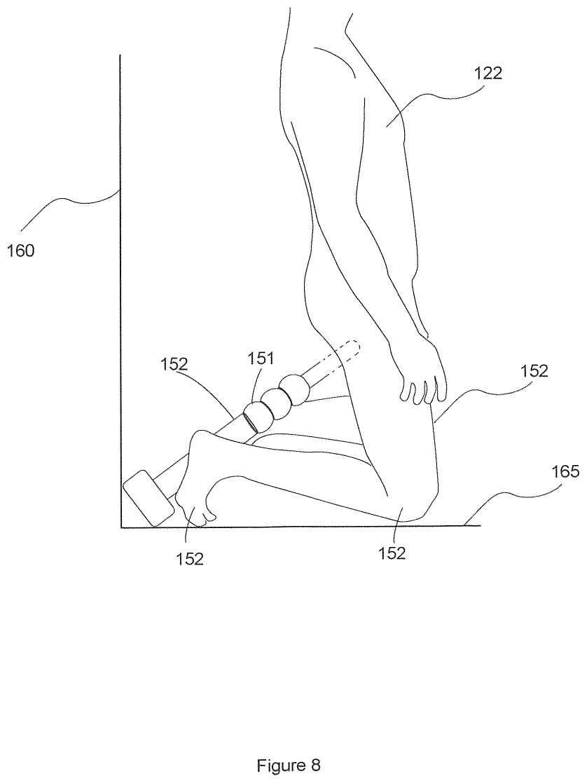

FIG. 8 shows the side perspective view of a user in an upright kneeling position using the invention with the insert attached to the 6061 grade aluminum tube or similar.

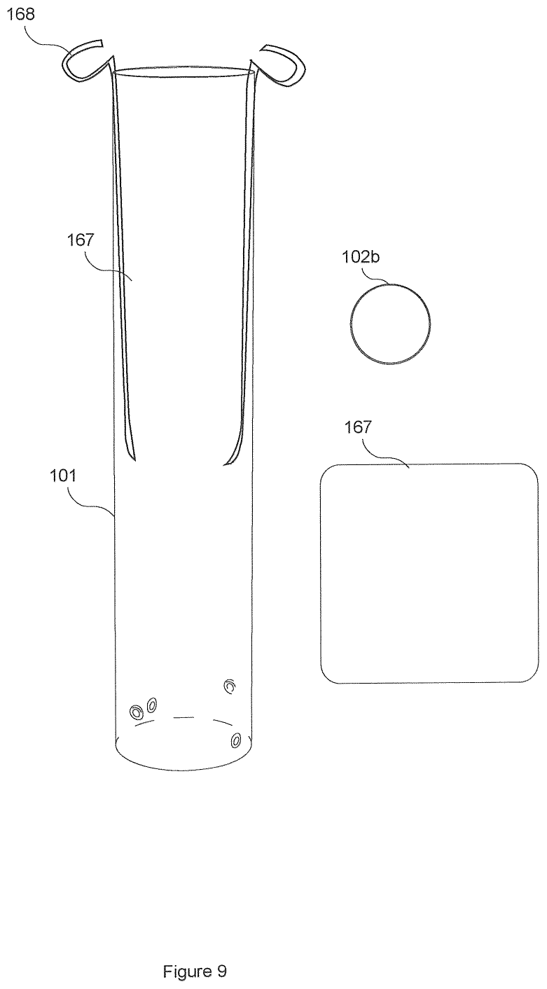

FIG. 9 shows a front view of the invention with a sheath inserted in to the opening of the aluminum

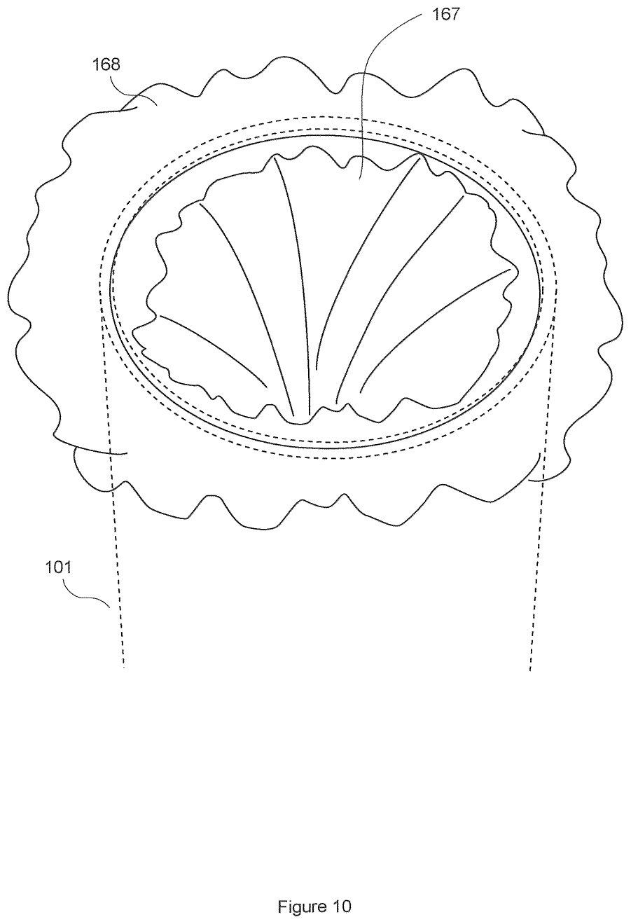

FIG. 10 shows a top perspective close-up view of the sheath overflowing the top of the 6061 grade aluminum tube or similar.

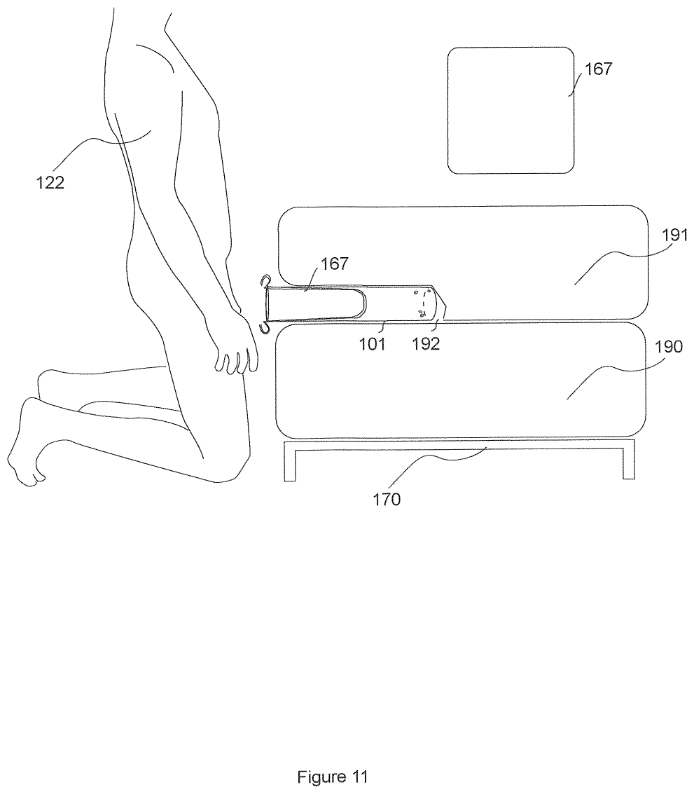

FIG. 11 shows side perspective view of a user in an upright kneeling position using the invention with the sheath inserted into the 6061 grade aluminum tube or similar.

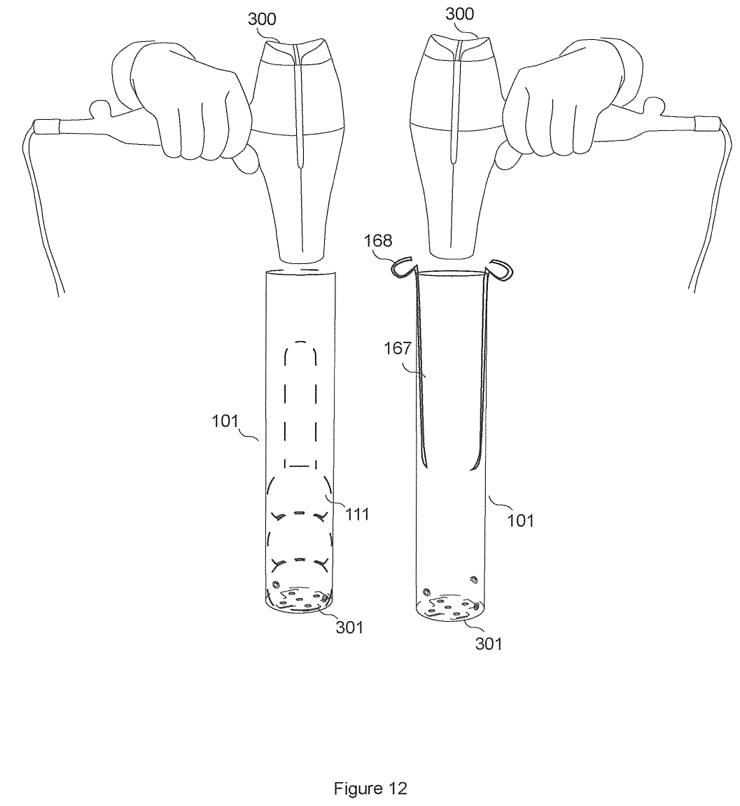

FIG. 12 shows two perspective views of a blow dryer above two tubes

### DETAILED DESCRIPTION OF THE INVENTION

Referring now to the invention in more detail, in FIG. 1, the component, 6061 grade aluminum tube or similar 101 which has a fixed length of 318 mm, an outside diameter of 64 mm 102a, and a 62 mm-63 mm opening 102b extending uniformly through the 6061 grade aluminum tube or similar, resulting in a rigid wall thickness of aluminum of 1-2 mm. The length could be fixed or user adjustable. At the base of the 6061 grade aluminum tube or similar 101 there are six ¼″ 20 threaded holes 103a. Three evenly distributed ¼″ 20 threaded holes 103a are made at 24.1 mm up from the base of the 6061 grade aluminum tube or similar 101. Three evenly distributed ¼″ 20 threaded holes 103a are made at 24.1 mm up from the base of the 6061 grade aluminum tube or similar 101 and three evenly distributed ¼″ 20 threaded holes 103a are made at 7.1 mm up from the base of 6061 grade aluminum tube or similar 101. The dimensions and shape were chosen as a starting point and are not meant to be a requirement of the invention.

FIG. 2 shows the 6061 grade aluminum tube or similar 101 which has a length of 318 mm, an outside diameter of 64 mm, an a 62 mm-63 mm opening extending uniformly through the 6061 grade aluminum tube or similar, resulting in a wall thickness of aluminum of 1-2 mm. At the base of the 6061 grade aluminum tube or similar there are six ¼″ 20 threaded holes 103a. Three evenly distributed ¼″ 20 threaded holes 103a are made at 24.1 mm up from the base of the 6061 grade aluminum tube or similar 101. Three evenly distributed ¼″ 20 threaded holes 103a are made at 24.1 mm up from the base of the 6061 grade aluminum tube or similar 101 and three evenly distributed ¼″ 20 threaded holes 103a are made at 7.1 mm up from the base of 6061 grade aluminum tube or similar 101. At the top of the 6061 grade aluminum tube or similar 101 is a watertight silicone seal 106 which fits precisely into the tube opening 105.

FIG. 3 shows two aluminum ridge rings 107. Three evenly distributed ¼″ 20 threaded holes 107a are shown in the two rings 107. The three evenly distributed ¼″ 20 threaded holes in 107a in the aluminum ridge rings 107 are placed so the ¼″ 20 threaded holes 107a in the aluminum ridge rings 107 line up with the six evenly distributed ¼″ 20 threaded holes 103a at the base of the 6061 grade aluminum tube or similar 101 and can be secured to keep the plus bridge with mount points 110 in a secure stable position at the base of the 6061 grade aluminum tube or similar 101. During assembly the one aluminum ridge ring 107 is anchored in position by three ¼″ 20 ⅜″ long stainless-steel set screws 103b 24.1 mm up from the base. The plus bridge with mount points 110 is layed to top of the first aluminum ridge ring 107. The second aluminum ridge ring 107 is anchored in position by three ¼″ 20 ⅜″ long stainless-steel set screws 103b 7.1 mm up from the base and secures the plus bridge with mount points 110.

FIG. 4 shows the top perspective view of plus bridge mount point 110 and the base of the 6061 grade aluminum tube or similar 101. Only the second of the two aluminum ridge rings 107 is seen and not pictured are three ¼″ 20 ⅜″ long stainless-steel set screws which hold the aluminum ridge ring 107 in place. The two aluminum ridge rings 107 hold the plus bridge with mount points 110 securely at the base of the 6061 grade aluminum tube or similar 101. A ¼″ 20 stainless-steel set screw measuring 38 mm in length is shown 110a the middle of the plus bridge with mount points 110. There is also a top view of the plus bridge 110 at the base of the page.

FIG. 5 shows a perspective view of the 6061 grade aluminum tube or similar 101 with the plus bridge with mounts points 110 in place and retaining an insertable device 111 within the 6061 grade aluminum tube or similar 101 with the watertight silicone seal 106. The plus bridge with mount points has opening which allows an air gap so the watertight silicone seal 106 is easy to insert. The gaps in the plus bridge with mount points 110 also allow air to flow through the 6061 grade aluminum tube or similar 101 so any commonly available hair dryer may be used to dry the insertable device 111 by blowing warm air into the 6061 grade aluminum tube or similar 101. Storage and drying rack function comprise one use of the multifunctional device in the configuration assembled in FIG. 5.

FIG. 6 shows front perspective view of first utility of a fully assembled dual-purpose invention 130. The components stacked in FIG. 6 comprise an insertable device 110 on top of the spherical safety collar 112 which is on top two spherical elevation components 114 held together by two double length barrels 115 and two ¼″ 20 set screws 117. The base of the two elevation components 114 is attached to the plus bridge with mount points 110 via a ¼″ 20 stainless steel set screw measuring 38 mm in length 110a. Any stable mounting system may be created to enable any insertable to be attached. The mounting systems are well known and broadly available. The mounting system shown in FIG. 6 is one system. The assembly fits within a flexible quadrilateral molded non-skid silicone tube base unit 119. In this instance the 6061 grade aluminum tube or similar 101 is acting as an elevation component. The assembly may also be placed in a commonly available foam roller.

FIG. 7 shows the front perspective view of a user of the invention in an upright kneeling position 120.

FIG. 8 is a side perspective view of a user in an upright kneeling position 122 on the floor 165 using the fully assembled invention in an angled position 151 against a wall 160 and resting on the floor 165. Note the four points of contact 152 of the user in an upright kneeling position 122 which forms a stable square base with two knees and two feet on the floor or bed. The fully assembled invention in an angled position 151 will add to the stability of the user in an upright kneeling position 122 and increase the safety while the invention is in use. Insertion into the body orifice(s) and precise location of pleasure delivering nerve center comprises the second utility of the multifunctional device in the configuration assembled in FIG. 8.

FIG. 9 shows a front view of the 6061 grade aluminum tube or similar 101 with flat fluffy material rolled into a tube shape 167. The flat fluffy material rolled into a tube shape 167 extends beyond the 6061 grade aluminum tube or similar 101 as a cushion for the edge 168 of the 6061 grade aluminum tube or similar 101. The flat fluffy material rolled into a tube shape 167 may be customized by the user into any shape and can be augmented with elastic bands to prevent skidding in the 6061 grade aluminum tube or similar 101 and provide structure. A top view of the 6061 grade aluminum tube or similar 102b and top view of the flat fluffy material 167 is shown to the right of tube drawing.

FIG. 10 shows a close-up view of the flat fluffy material rolled into a tube shape 167 extending beyond the 6061 grade aluminum tube or similar 101 as a cushion for the edge 168 of the 6061 grade aluminum tube or similar 101.

FIG. 11 shows a side view of the 6061 grade aluminum tube or similar 101 placed in between a mattress 191 and a box spring 190 on a bed stand 170. The 6061 grade aluminum tube or similar 101 structure provides an opening between the mattress and the box spring 192. The 6061 grade aluminum tube or similar 101 has the flat fluffy material rolled into a tube shape 167 inside and a side perspective view of a user in an upright kneeling position 122 using the multifunctional device as an artificial body orifice (mouth, vagina, rectum) of a fully assembled invention 195. Experiencing the artificial body orifice function comprises the second utility of the multifunctional device in the configuration assembled in FIG. 11.

FIG. 12 shows a one perspective view of a blow dryer held 300 at the top of a 6061 grade aluminum tube or similar 101 to blow through the tube to quickly dry the insert 111. The air would pass through the bottom of the 6061 grade aluminum tube or similar 101 through the air holes 301. FIG. 12 also shows a perspective view of a blow dryer held 300 at the top of a 6061 grade aluminum tube or similar 101 with the collar of the flat fluffy material 168 and blowing through the flat fluff material 167 through the air holes 301.

The endogenous opioids and their receptors are widely distributed throughout the central and peripheral nervous systems. These systems regulate pain, emotion, reward, stress responses, motivation, and autonomic control. The invention is designed to activate the nervous system which releases endogenous opioids into the user's body peripheral nervous system. A wide range of endogenous opioid-related effects may be activated by a user interacting with this invention.

The advantages of the present invention include, without limitation, portability, quick and easy assemblage, adjustable elongation, and the invention stands on porous and non-porous surfaces wood, vinyl, tile metal or plastic.

There are as many applications of the present invention as there are applications of flexible and rigid materials.

While the foregoing written description of the invention enables one of ordinary skill to make and use what is considered the best mode thereof, those of ordinary skill will understand and appreciate the existence of variations, combinations, and equivalents of the specific embodiment, method, and examples herein. The invention should therefore not be limited by the described embodiments, methods and examples, but by all embodiments and methods within the scope and spirit of the invention as claimed.

What is claimed is:

1. A rigid tube with elements for quick connection, retention, alignment and motion control system for connecting, aligning and controlling motion during hands-free insertion.
